(19) United States
(12) Patent Application Publication
(10) Pub. No.: US 2019/0200807 A1
(43) Pub. Date: Jul. 4, 2019

(54) Cooking Robot Fry Pan

(71) Applicant: TIANJIN DISCOVERER KITCHEN ROBOT SCIENCE AND TECHNOLOGY LIMITED COMPANY, Tianjin (CN)

(72) Inventors: Xiaobo Yin, Daqing (CN); Wenhua Ge, Daqing (CN); Hukun Yang, Daqing (CN)

(21) Appl. No.: 16/351,481

(22) Filed: Mar. 12, 2019

Related U.S. Application Data
(63) Continuation of application No. PCT/CN2017/100792, filed on Sep. 6, 2017.

(30) Foreign Application Priority Data
Sep. 30, 2016 (CN) 201621097057.9

(51) Int. Cl. A47J 37/10; B25J 9/00

(52) U.S. Cl. CPC A47J 37/108; B25J 9/0003

(57) ABSTRACT

The present disclosure relates to a cooking robot fry pan which comprises a pan body and a stirrer, wherein shaft bases are symmetrically arranged on the pan body; the shaft bases are composed of shaft sleeves and fixing sleeves; an exterior eave is arranged at one end of each shaft sleeve; bolt holes are uniformly distributed in the exterior eaves; the fixing sleeves are connected with the pan body; the shaft sleeves are positioned inside the fixing sleeves; the exterior eaves of the shaft sleeves are positioned at ports of the fixing sleeves; bolt holes are uniformly formed in the ports of the fixing sleeves; the exterior eaves of the shaft sleeves and the fixing sleeves penetrate through bolt holes in a one-to-one correspondence manner through bolts and are fixedly connected. Coaxiality of the shaft sleeves is ensured, and the stirrer stirrers smoothly.

### CROSS REFERENCE TO RELATED APPLICATIONS

The present application is a Continuation Application of PCT Application No. PCT/CN2017/100792 filed on Sep. 6, 2017, which claims the benefit of Chinese Patent Application No. 201621097057.9 filed on Sep. 30, 2016. All the above are hereby incorporated by reference.

### TECHNICAL FIELD

The present disclosure relates to a cooking robot auxiliary facility, and in particular to a cooking robot fry pan.

### BACKGROUND

A fry pan is a Chinese cooking tool and is one of pots. The fry pan has the characteristic of a large opening in the top and a round bottom. The fry pan is mainly used for frying foods, and also has other different cooking methods such as steaming, stewing and frying with oil. Along with development of science, a cooking robot already makes service in social life, the cooking robot has a function of one pot with multiple functions such as automatic food turnover, frying with oil, quick frying, braising, steaming, boiling, baking and stewing, and automatic and interesting food frying is easily achieved; along with use of the cooking robot, a fry pan used in match with the cooking robot is also well liked by people. However, a stirrer in a pan body of a conventional robot fry pan has problems that shaft sleeves are symmetrically arranged on the pan body, the shaft sleeves are connected with the pan body in a welded manner, one end of the stirrer is connected with a support shaft penetrating through one shaft sleeve, the other end of the stirrer is connected with a transmission shaft penetrating through the other shaft sleeve, the shaft sleeves are diameter-variable cylindrical bodies with two steps on inner walls, the transmission shaft is at a state of decentraction with the support shaft when being rotated, then the stirrer does not turn over smoothly in the pan body, the inner wall of the pan body may be scraped, and thus perfection of the robot fry pan is affected.

### SUMMARY

The present disclosure aims to provide a cooking robot fry pan and aims to solve the problem that a stirrer of a conventional robot fry pan may be unsmooth in stirring sometimes.

According to the technical scheme of the present disclosure to solve the technical problem, the cooking robot fry pan includes a pan body and a stirrer; shaft sleeves are symmetrically arranged on the pan body; the shaft bases are composed of shaft sleeves and fixing sleeves; the fixing sleeves are cylinders; the shaft sleeves are diameter-variable cylindrical bodies; an exterior eave is arranged at one end of each shaft sleeve; bolt holes are uniformly distributed in the exterior eaves; the fixing sleeves are connected with the pan body in a welded manner; the shaft sleeves are positioned inside the fixing sleeves; the exterior eaves of the shaft sleeves are positioned at ports of the fixing sleeves; bolt holes are also uniformly formed in the ports of the fixing sleeves; the exterior eaves of the shaft sleeves and the fixing sleeves penetrate through bolt holes in a one-to-one correspondence manner through bolts and are fixedly connected.

In the scheme, sealing rings are arranged between the shaft sleeves and the fixing sleeves.

In the scheme, two circles of the sealing rings are available.

### Beneficial Effects

The present disclosure is convenient in processing; when two processing sides are welded with the fixing sleeves on the pan body, because of an identical inner diameter of the fixing sleeves, one processing procedure may be implemented, inner holes of the fixing sleeves on both sides are coaxial after being processed, coaxiality is ensured when the shaft sleeves are mounted on the fixing sleeves on both sides, and thus the stirrer stirs smoothly.

### BRIEF DESCRIPTION OF THE DRAWINGS

FIG. 1 shows a partial sectioned view of the present disclosure;

FIG. 2 shows a side view of the present disclosure;

FIG. 3 shows a partial enlarged drawing of a part I in the FIG. 1;

FIG. 4 shows a top view of the present disclosure.

1 pan body 2 stirrer 3 shaft base 4 shaft sleeve 5 fixing sleeve 6 exterior eave 7 bolt 8 sealing ring.

### DETAILED DESCRIPTION OF THE EMBODIMENTS

The present disclosure is further described with drawings

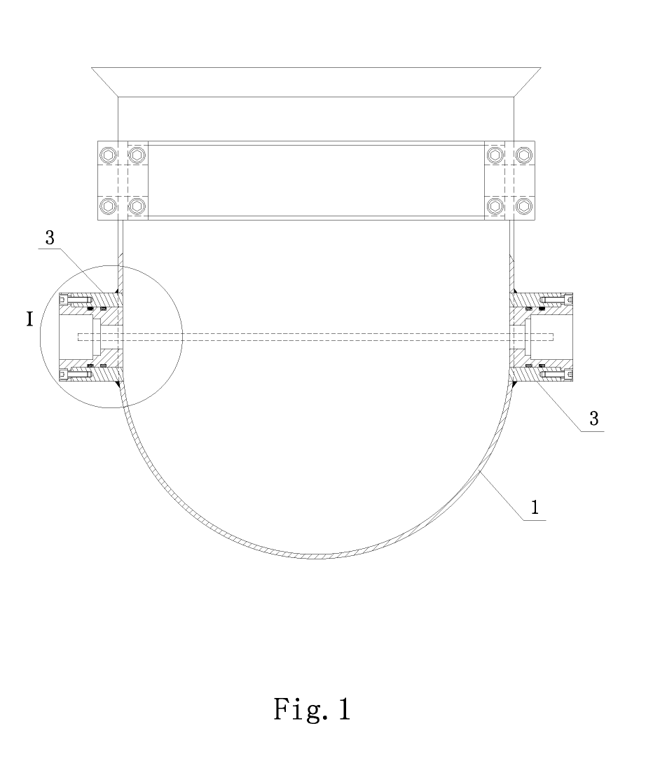

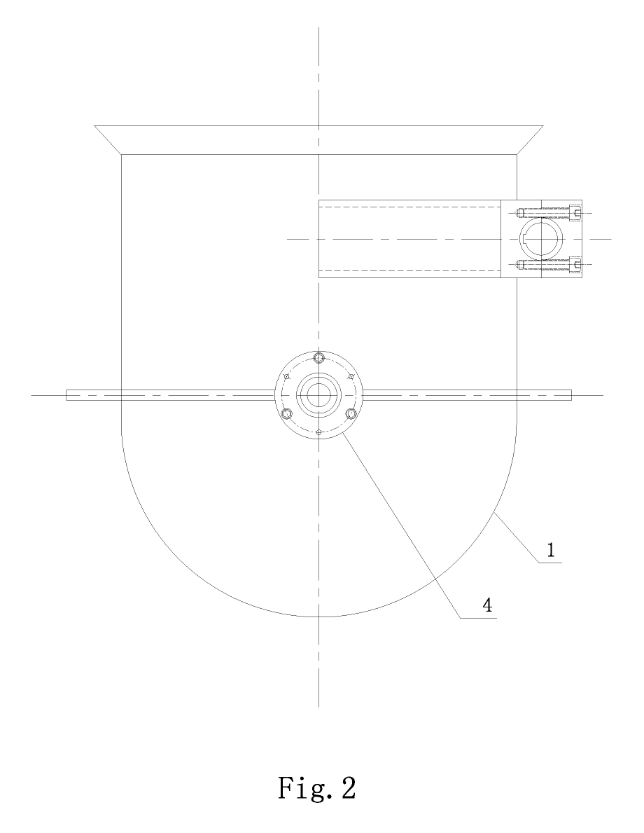

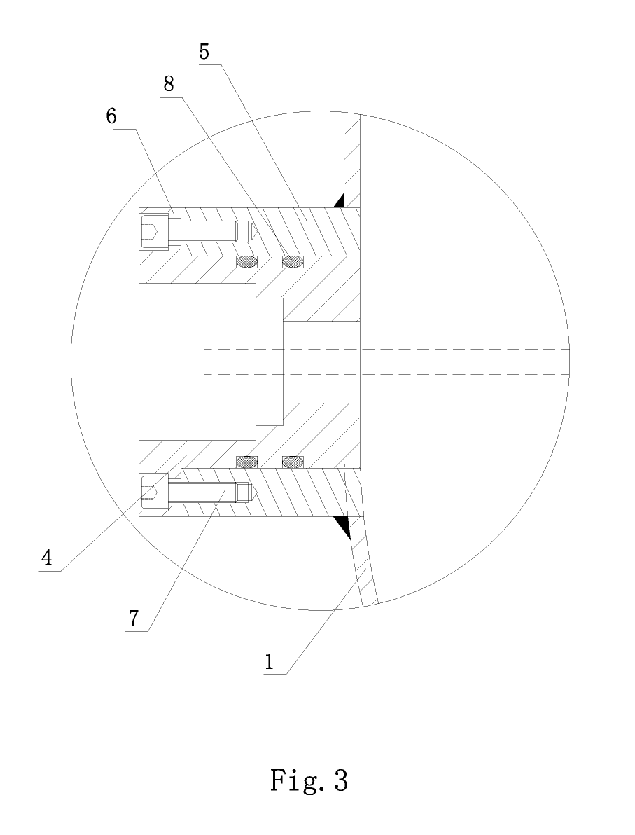

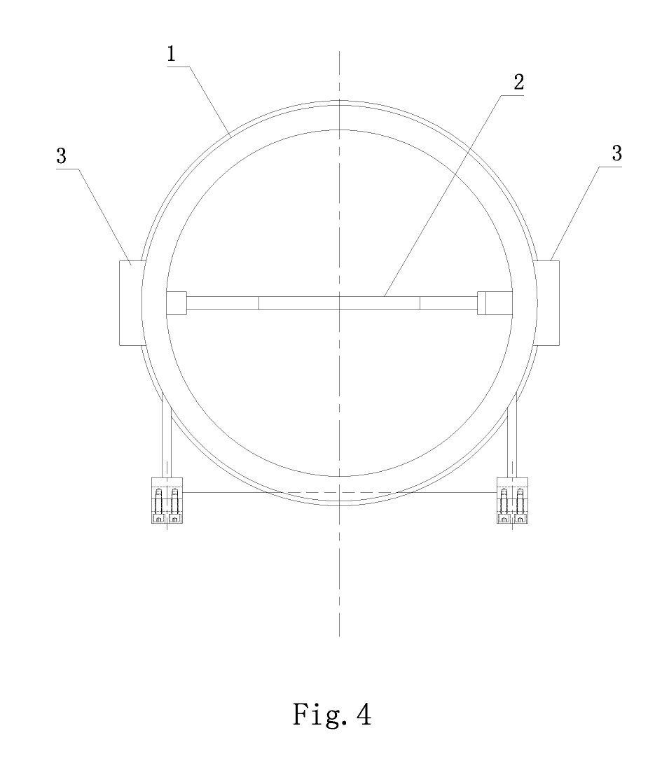

As shown in FIG. 1, FIG. 2 and FIG. 4, a cooking robot fry pan includes a pan body 1 and a stirrer 2, and shaft bases 3 are symmetrically arranged on the pan body 1; as shown in FIG. 3, the shaft bases 3 are composed of shaft sleeves 4 and fixing sleeves 5; the fixing sleeves 5 are cylinders; the shaft sleeves 4 are diameter-variable cylindrical bodies; an exterior eave 6 is arranged at one end of each shaft sleeve 4; bolt holes are uniformly distributed in the exterior eaves 6; the fixing sleeves 5 are connected with the pan body 1 in a welded manner; the shaft sleeves 4 are positioned inside the fixing sleeves 5; the exterior eaves 6 of the shaft sleeves 4 are positioned at ports of the fixing sleeves 5; bolt holes are also uniformly formed in the ports of the fixing sleeves 5; the exterior eaves 6 of the shaft sleeves 4 and the fixing sleeves 5 penetrate through bolt holes in a one-to-one correspondence manner through bolts 7 and are fixedly connected; sealing rings 8 are arranged between the shaft sleeves 4 and the fixing sleeves 5, and thus sealing of the shaft sleeves 4 and the fixing sleeves 5 is achieved.

The stirrer 2 may be an arc-shaped rod; when the present disclosure is used, one end of the stirrer 2 is connected with a support shaft through a shaft base 3, and the other end of the stirrer 2 is connected with a transmission shaft through the other shaft base 3.

What is claimed is:

1. A cooking robot fry pan, comprising a pan body (1) and a stirrer (2), wherein shaft bases (3) are symmetrically arranged on the pan body (1); the shaft bases (3) are composed of shaft sleeves (4) and fixing sleeves (5); the fixing sleeves (5) are cylinders; the shaft sleeves (4) are diameter-variable cylindrical bodies; an exterior eave (6) is arranged at one end of each shaft sleeve (4); bolt holes are uniformly distributed in the exterior eaves (6); the fixing sleeves (5) are connected with the pan body (1) in a welded manner; the shaft sleeves (4) are positioned inside the fixing sleeves (5); the exterior eaves (6) of the shaft sleeves (4) are positioned at ports of the fixing sleeves (5); bolt holes are also uniformly formed in the ports of the fixing sleeves (5); the exterior eaves (6) of the shaft sleeves (4) and the fixing sleeves (5) penetrate through bolt holes in a one-to-one correspondence manner through bolts (7) and are fixedly connected.

2. The cooking robot fry pan as claimed in claim 1, wherein sealing rings (8) are arranged between the shaft sleeves (4) and the fixing sleeves (5).

3. The cooking robot fry pan as claimed in claim 2, wherein two circles of the sealing rings (8) are available.
